(19) United States
(12) Patent Application Publication
(10) Pub. No.: US 2022/0407042 A1
(43) Pub. Date: Dec. 22, 2022

(54) RECHARGEABLE SOLID-STATE LITHIUM ION BATTERY

(71) Applicant: ELECTROVAYA INC., Mississauga (CA)

(72) Inventors: Sankar DASGUPTA, Mississauga (CA); Colin BRIDGES, Mississauga (CA); Rajshekar DASGUPTA, Mississauga (CA); Elmira Memarzadeh, Mississauga (CA)

(73) Assignee: ELECTROVAYA INC., Mississauga (CA)

(21) Appl. No.: 17/696,649

(22) Filed: Mar. 16, 2022

Related U.S. Application Data
(60) Provisional application No. 63/190,205, filed on May 18, 2021.
(60) Provisional application No. 63/161,574, filed on Mar. 16, 2021.

(51) Int. Cl. H01M 4/04; H01M 10/0565; H01M 10/0525

(52) U.S. Cl. CPC H01M 4/0407; H01M 10/0565; H01M 10/0525; H01M 2300/0082; H01M 2300/0085

(57) ABSTRACT

An electrochemical cell and a method of preparing the electrochemical cell are provided. The electrochemical cell, such as a lithium battery or a solid-state lithium ion battery, includes a first electrode having a solid polymer electrolyte deposited thereon, wherein the solid polymer electrolyte comprises a microporous polymer swollen with an organic carbonate liquid and a dissociable lithium salt, and a second electrode. The method of preparing an electrochemical cell includes providing the first electrode, immersing the first electrode in an electrolyte solution, depositing the solid polymer electrolyte on the immersed first electrode, and attaching the second electrode to an exposed surface of the solid polymer electrolyte, thereby forming the electrochemical cell. During operation, the solid polymer electrolyte is capable of growing a passivating polymer layer at an interface between the first electrode and the solid polymer electrolyte.

### CROSS-REFERENCE TO RELATED APPLICATIONS

The present application claims priority to and the benefit of the U.S. Provisional Patent Application No. 63/161,574, filed Mar. 16, 2021, titled “Rechargeable Solid-State Lithium Ion Battery” and U.S. Provisional Patent Application No. 63/190,205, filed May 18, 2021, titled “Rechargeable Solid-State Lithium Ion Battery,” which are hereby incorporated by reference in their entireties as if fully set forth below and for all applicable purposes.

### FIELD OF INVENTION

The disclosure relates to materials and designs for electrochemical energy storage devices, such as lithium ion batteries, and in particular relates to polymeric materials or polymer ceramic composite materials for lithium ion conductors and electrode separators for solid-state rechargeable lithium ion batteries. This invention also relates to methods for manufacturing rechargeable batteries, including solid-state lithium ion batteries.

### BACKGROUND

Lithium ion batteries generally include an anode (negative electrode), a cathode (positive electrode), an electrolyte for conducting lithium ions between the anode and cathode, and a separator that prevents electrical conductivity between the anode and cathode while providing free passage for lithium ions. Conventional separators used in lithium ion batteries are microporous films, while conventional electrolytes used in lithium ion batteries are volatile flammable solvents, which can cause significant safety concerns as the lithium ion battery degrades over time.

Solid ceramic electrolytes have been developed to solve this problem, as they are less volatile and less flammable than the conventional electrolytes. However, significant problems also arise in solid ceramic electrolytes due to their brittle nature, for example, when operating in environments with vibrations and other shock forces. Such presence of vibrations and shock forces during a typical use, e.g., of an electric vehicle, can cause solid electrolytes in the battery pack to crack and fracture. Further, such physical damages or alterations also decrease ionic conductivity of the electrolyte itself, thereby causing a reduction in battery performance. Therefore, there is a need for fracture resistant solid electrolytes that can increase safety while alleviating the aforementioned short-comings of currently available solid ceramic electrolytes to improve the performance lithium ion batteries during routine usage, e.g., of electric vehicles. Furthermore, the interface of such solid electrolytes, including ceramic electrolytes, to the electrode is often poor, leading to large impedance due to the poor quality interface.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A illustrates an example embodiment of an electrochemical cell, in accordance with various embodiments.

FIG. 1B illustrates an example embodiment of a bipolar electrochemical cell, in accordance with various embodiments.

FIG. 2 illustrates a method of preparing a lithium battery, in accordance with various embodiments.

FIG. 3 illustrates a method of preparing an electrochemical cell, in accordance with various embodiments.

FIG. 4 illustrates a method of preparing a solid-state electrochemical cell, in accordance with various embodiments.

FIG. 5 illustrates a method of preparing an electrochemical cell, in accordance with various embodiments.

FIG. 6 illustrates a method of preparing a bipolar electrochemical cell, in accordance with various embodiments.

FIGS. 7A and 7B illustrate plots 700a and 700b, respectively, showing X-ray photoelectron spectroscopy (XPS) results, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The technologies disclosed herein relate to flexible, fracture resistant solid polymer electrolytes (also referred to herein as “solid electrolyte(s)” or “polymer electrolyte(s)”) and solid polymer ceramic composites/electrolytes (also referred to herein as “solid polymer ceramic composite electrolyte(s)” or “polymer ceramic composite electrolyte(s)”) that can be used in lithium ion batteries that can improve performance as well as safety while alleviating the aforementioned short-comings of currently available solid ceramic electrolytes or solid polymer electrolytes, or hybrids thereof.

Electrodes are electroactive energy storage components in a typical lithium ion battery. While some electrodes are in a form of conductive metal foils, some metal foils may be coated with about 10-100 μm of electroactive composite material. For an anode, the electroactive material can be a lithium foil, lithiated carbon powder (e.g. lithiated graphite or other forms of LiC₆) or a lithium ceramic glass (e.g. Li₄Ti₅0i₂, Si(Li_{4,4}Si) or Ge (Li_{4,4}Ge)) bound together with polyvinylidene fluoride (PVDF). For a cathode, the electroactive material can typically be a lithiated metal oxide (e.g. LiCoO₂, LiFePO₄, LiMn₂O₄, LiNiO₂, Li₂FePO₄F, or Li(LiₐNiₓMn_{y}Co_{z})) mixed with a conductive carbon additive (e.g. carbon fiber, carbon black, acetylene black), and bound together with PVDF.

A typical lithium ion battery uses a separator to prevent electrical conductivity while facilitating conduction of lithium ions between the anode and cathode. The separator is designed to allow free passage of lithium ions but block electrical conductivity between the anode and cathode, which would cause a dangerous short circuit. Conventional separators used in lithium ion batteries are microporous polypropylene films having a thickness of 20-70 microns with a porosity of 20-80%, for example, described by Zhang, Z. et. al. in U.S. Pat. No. 6,432,586B1, granted on Aug. 13, 2002. The inclusion of a separator unavoidably increases the ionic resistance of the battery, as described by Liu, J. et. al. in the Journal of Solid-state Electrochemistry 23, 277 in 2019. The separator must be thick enough to impart sufficient mechanical strength to prevent short circuiting, but thin enough to retain sufficient ionic conductivity. The lithium ion conductivity and lithium inventory of the electrolyte impact the maximum current that a battery can achieve. Highly porous separators maximize lithium inventory and, as much as possible, help prevent the loss of ionic conductivity that accompanies the inclusion of a separator. This comes with a trade-off, as more porous membranes will be weaker and provide less protection against short circuiting. Separator components can also increase the cost of materials and complexity of the manufacturing process for lithium ion batteries, with the separator accounting for up to 10% of the total cost of manufacturing a lithium ion battery. As such, it becomes apparent that a solid or polymer gel electrolyte that can reliably block electrical conductivity as a thin film may lower production costs and improve ion conductivity.

The electrolyte contains a dissociable lithium salt having a lithium cation and an inorganic anion (e.g. lithium hexafluorophosphate, lithium tetrafluoroborate, lithium triflate, lithium bistriflimide, or lithium 2-Trifluoromethyl-4,5-dicyanoimidazolide (LiTDI)), or some mixture thereof dissolved in an organic liquid or polymer gel (e.g. ethylene carbonate, propylene carbonate, dimethyl carbonate, ethyl-methyl carbonate, fluorinated ethylene carbonate, polyethylene oxide, or some mixture thereof). The electrolyte must be able to conduct lithium ions between the anode and cathode, and can either be a solid, liquid, or mixture of both.

Liquid electrolytes can include volatile and flammable solvents, causing significant safety concerns as the lithium battery degrades over time. Solid polymer electrolytes are developed to counteract this problem, as polymer electrolytes are less volatile and less flammable. Since polymer electrolytes are also electrically insulating, the material strength of the polymer determines whether or not a mechanically robust separator membrane is also needed or if the polymer electrolyte can fill both roles. Polymer electrolytes must be flexible and polar to conduct ions efficiently, and classes of ion conducting polymers include polysiloxanes (as described by Buisine et. al. in worldwide patent no. WO₂₀₁₆₉₉₅₅A1, filed on Apr. 20, 2016), polycarbonates (as described by Smith et. al. in U.S. Pat. No. 7,354,531B2, granted on Apr. 8, 2008), polyethylene oxides and other polyglycols (as described by Vissers, et. al. in U.S. Pat. No. 7,226,702B2, granted on Jun. 5, 2006), or acrylates (as described by Nishi et. al. in U.S. Pat. No. 5,609,795A, granted on Mar. 11, 1997). Polymer electrolytes can also be mixtures of these polymers/copolymers in varying amounts with each other or other polymers, like PVDF, to provide structural support. Soft and flexible polymers have higher ionic conductivities, but their poor mechanical strength means a large thickness and an electrically insulating separator prevents short circuiting, with many of the previous patents having a thickness of greater than 20 microns. Soft polymers combined with a mechanically robust separator to form a composite polymer/electrolyte have been described, for example by Das Gupta et. al. in Canadian patent no. 2321431, granted on Dec. 14, 2001. In general, polymer electrolytes include thicker electrolyte layers and additional polymer separator membranes, increasing the ionic conductivity of the battery. Because of this, polymer electrolyte systems need to be operated at temperatures above typical battery operation conditions (−20 to 40° C.) as described in the patents above, by M. Zafar et. al. in Canadian patent no. CA2382118A1, filed on Aug. 21, 2000, and by Kelly et al. in J. Power Sources, 14, 13 in 1985. Solid ceramic ion conductors are mechanically strong enough to reliably electrically separate the electrodes without an extra separator component, but typically at the cost of low ion conductivity. Solid-state ceramic electrolytes contain a lithium conductivity of 10⁶-10⁻³ S/cm between 100-150° C., as described by Waschman et. al. in United States patent no. 20140287305A1, granted on Apr. 14, 2020. Solid ceramic electrolytes can have a lower conductivity than polymer electrolytes at low temperatures, and the increase in resistance of the system reduces the overall battery performance. Taking the trade-off between polymer conductivity and mechanical strength into account when determining how thick or thin a polymer needs to be is critical when designing electrolyte/separators. As such, it is apparent that a polymer of moderate strength and moderate ion conductivity that strongly adheres to an electrode may be useful in allowing polymer electrolytes to provide good electronic insulation between electrodes in a thin enough layer to retain good ion conductivity. This would allow a solid-state polymer battery to operate safely with good power output characteristics at room temperature.

For solid/ceramic electrolytes, significant problems also arise due to the brittle nature of ceramics when operating in environments with vibrations and other shock forces. Vibrations and shock forces present during typical use of an EV cause ceramic electrolytes to crack and fracture. This decreases the ionic conductivity of the electrolyte, reducing battery performance for all anode/cathode combinations. An additional advantage of our soft-polymer electrolyte is that it is soft and flexible and does not fracture when subjected to the vibrations that occur during normal operation of electric vehicles.

The polymer electrolyte and polymer composite electrolyte disclosed herein are provided for use in an electrochemical cell or a rechargeable solid-state lithium ion battery. The disclosed polymer electrolyte comprises an inert microporous crosslinked polymer carrying a dissociable lithium salt that can function as the ion conducting component and the mechanically robust electrically insulating separator. This solid-state polymer is not volatile, reducing flammability risks, and forms on the electrode due to a chemical reaction initiated on the electrode surface. The approach of growing the ion conducting/electrically insulating polymer on the electrode surface imparts a robust adherence to the anode, allowing a relatively thin layer to effectively prevent short circuiting while limiting high ionic resistances that result from thick polymer electrolyte layers. This polymer can also be impregnated with a plasticizing organic carbonate liquid carrying a dissociable lithium salt of either the same or a different composition as the dissociable lithium salt present in the material to increase lithium inventory in the electrolyte and increase lithium ion conductivity. The polymer can also be mixed with an ion-conducting ceramic material to form a polymer ceramic composite material. The ion conducting ceramic or inorganic materials can comprise one or more of the following materials, including but not limited to lithium conducting sulphides, e.g., Li₂S, P₂S₅; lithium phosphates, e.g., Li₃P; or lithium oxides, e.g., lithium lanthanum titanium oxide, lithium lanthanum zirconium oxide, or the like.

The combined polymer separator/electrolyte or polymer ceramic composite separator/electrolyte may be obtained by applying a highly reducing chemical/electrochemical environment to the anode or cathode while the electrode is submerged in an electrolyte solution containing, at least in part, a carbonate-based organic liquid and a LiTDI-based dissociable lithium salt. LiTDI is well known as an electrolyte that is water stable and can allow for long life lithium ion batteries when used in concentrations of between 1 ppm and 10 ppm, as described by Bonnet et. al. in United States patent no. 20160380309A1, published on Dec. 29, 2016. The process by which LiTDI initiates a polymerization reaction of a carbonate solvent has been described by Abraham et. al. in the Journal of Physical Chemistry C, 50, 28463, in 2016. For this reason, the use at least in part of LiTDI (between 0.1M and 1.5M) as the dissociable lithium salt is critical to this invention.

The reaction of LiTDI in a highly reducing environment produces 2 equivalents of lithium fluoride and one equivalent of a lithium 2-fluoromethylene-4,5-dicyanoimidazolide anion (LiTDI−). The LiTDI− anion initiates an anionic ring opening polymerization of organic carbonate liquids to form a polycarbonate type polymer with a final composition that depends on the carbonate solvent mixture (monomers) used. In this invention, ethylene carbonate, dimethyl carbonate, ethyl-methyl carbonate, propylene carbonate, and fluorinated ethylene carbonate in a mixture on their own or mixed with ion conducting ceramic/inorganic materials to create a composite, can all be used in varying amounts to form the adhered polycarbonate polymer layer on the electrode. Different ratios of these carbonate liquids will impart different microstructures, crosslinking amounts, and ionic conductivities to the polymer electrolyte/separator or if including an ion conducting ceramic, a polymer electrolyte ceramic composite/separator. In particular fluorinated ethylene carbonate is used as a crosslinking agent, which ultimately determines the mechanical strength, thickness, and the ionic/electronic resistivity of the polymer electrolyte/separator and polymer ceramic composite electrolyte/separator layers. A highly crosslinked polymer electrolyte/separator or polymer ceramic composite electrolyte/separator is mechanically robust, but contains a smaller lithium inventory than thicker, less crosslinked layers. As such, a balance must be struck to find a crosslinking amount that contains a good ionic conductivity and sufficient lithium inventory. A polymer separator/electrolyte or polymer ceramic composite electrolyte/separator layer having a thickness of between 0.1-10 microns resulting from a fluorinated ethylene carbonate concentration of 10 ppm to 100,000 ppm achieves that balance. In general, this polymerization results in lithium fluoride and a lithium ion conductive polymer being deposited onto the electrode, which may also be viewed as a composite of a solid electrode interface (SEI) and a flexible electrolyte/separator all in one. The LiTDI− anion which initiates the polymerization of carbonates may be formed by reacting LiTDI with lithium metal, with a lithiated graphite anode, with a lithiated ceramic glass anode, or by electrochemical reduction onto the cathode surface.

In the case of lithium metal anodes, the formation of lithium dendrites has been shown to be a significant enough safety concern to make them not commercially viable in rechargeable batteries. Single crystal solid electrolytes are sought after as solid electrolytes as they are shown to prevent lithium dendrites from forming. Unfortunately, as fractures form in the electrolyte crystal due to vibrations and shock forces due to their brittle nature, dendrites can begin to form within the cracks, and the solid-state battery becomes unsafe for long term use (described by Guo, X et. al. in Electrochemical Energy Reviews, published on Jul. 27, 2020 and Y.-B. He et. al. in Frontiers in Materials, published on Mar. 25, 2020). While lithium dendrites are generally able to form in solid polymer electrolytes no matter their elastic modulus (described by Zhang, Q. et. al. in ACS Energy Letters, published on Feb. 7, 2020). The electrolyte system allows for “self-healing” of our polymer electrolyte/separator/SEI or polymer ceramic composite electrolyte/separator/SEI, stopping dendrite growth as soon as they form in the SEI. The self-healing property arises as a result of the aforementioned reaction between Lithium metal, LiTDI, and carbonate solvents to form a passivating polymer layer on Lithium. As lithium dendrites begin to form, it necessarily means that new bare lithium metal surfaces become exposed that aren't passivated by the existing SEI. Once this happens, LiTDI and ethylene carbonate present in the swollen polymer electrolyte will react with lithium to renew the SEI and form the previously described lithium ion conducting polymer electrolyte/separator or polymer ceramic composite electrolyte/separator. Dendrite growth traditionally speeds up after their initial formation, since the sharp dendrite points cause an increased current density on the dendrite during charging. This passivation by reforming an SEI will effectively prevent dendrite growth by stopping them before they reach their most rapid growth stage. This novel electrolyte system allows for re-growth of a passivating lithium ion conducting, imbuing our polymer electrolyte/separator system with its self-healing properties that are critical for safely operating through many charge/discharge cycles by preventing lithium dendrite growth.

The combined polymer separator/electrolyte or polymer ceramic composite electrolyte/separator may be formed on the anode (e.g. lithium foil, lithiated carbon powder such as lithiated graphite or other forms of LiC₆ or a lithium ceramic glass such as Li₄Ti₅0₂, Li_{4,4}Si or Li_{4,4}Ge bound together with PVDF) due to the highly reducing nature of the anode itself. A chemical reaction between LiTDI and the anode initiates a polymerization reaction of the carbonate solvent on its surface. In this case the electrolyte mixture can be an organic liquid mixture containing some amount of ethylene carbonate, dimethyl carbonate, ethyl-methyl carbonate, propylene carbonate, and fluorinated ethylene carbonate with other organic liquids, LiTDI, and other soluble lithium salts.

The polymer electrolyte/separator or polymer ceramic composite electrolyte/separator containing a dissociable lithium salt is placed between an anode and a cathode, thereby forming a rechargeable solid-state lithium ion battery when combined with appropriate current collectors and packaging.

In accordance with various embodiments, the disclosure includes a method for manufacturing a solid polymer electrolyte or polymer ceramic composite electrolyte/separator with self-healing properties using one or more of the following steps of a, b, c, and d, as follows:

Step a: Creating an electrolyte solution comprising organic carbonates (e.g. ethylene carbonate, dimethyl carbonate, ethyl-methyl carbonate, propylene carbonate, fluorinated ethylene carbonate, or some mixture thereof) containing lithium TDI and other dissociable lithium salt electrolytes in varying amounts (e.g. lithium hexafluorophosphate, lithium tetrafluoroborate, lithium triflate, lithium bistriflimide) in a concentration between 0.1 M and 1.5 M. In particular, amounts of fluorinated ethylene carbonate of 10-100,000 ppm and LiTDI in concentrations of 0.1-1.5M are used, with other amounts of carbonates and dissociable lithium salts being used to optimize the mechanical, electronic, and ionic properties of the polymer electrolyte/separator.

Step b: Submerging the anode in the electrolyte solution such that the polymer electrolyte/separator forms on the exposed face of the anode due to a reaction between lithium, LiTDI, and the carbonate liquids. The anode can also include highly reductive materials such as lithiated graphite or other forms of LiC₆, or a lithium ceramic glass (e.g. Li₄Ti₅0i₂, Si(Li_{4,4}Si) or Ge (Li_{4,4}Ge)) bound together with PVDF (polyvinylidene fluoride). The anode is submerged in the electrolyte solution for a length of time such that the polymer electrolyte/separator has reached a thickness between 0.1 microns to 10 microns. When the anode is removed from the electrolyte solution, the now adherent polymer electrolyte/separator layer is swollen with excess organic carbonate liquids and dissociable lithium salts, which may be used in the final assembled battery.

In various embodiments, the anode is lithium metal and the current collector is a 5-200 micron thick metal mesh. In various embodiments, the current collector comprises copper, aluminum, or stainless steel. In various embodiments, the current collector is a porous current collector or a mesh current collector. In various embodiments, the pores in the porous current collector are filled with lithium metal. In various embodiments, the mesh current collector is between 25%-75% porous.

According to another aspect of the disclosure, the cathode can be submerged in the electrolyte solution containing the aforementioned dissociable lithium salt and organic carbonate liquids, and the polymer electrolyte/separator can be grown from the exposed face of the cathode by applying an electrochemically reducing potential to the cathode similar to the reduction potential of lithium metal (e.g. ˜0.1 V versus Li/Li+). The cathode can include a lithiated metal oxide (e.g. LiCoO₂, LiFePO₄, LiMn₂O₄, LiNiO₂, Li₂FePO₄F) mixed with a conductive carbon additive (e.g. carbon fiber, carbon black, acetylene black, etc.), and bound together with PVDF. In various embodiments, an electrochemical potential is applied until the polymer electrolyte/separator is found to have a thickness in the range of 0.1-10 microns. When the cathode is removed from the electrolyte solution, the now adherent polymer electrolyte/separator layer is swollen with excess organic carbonate liquids and dissociable lithium salts of the above listed composition, which may be used in the final assembled battery.

According to various embodiments, an electrode can include a structural supporting polymer mesh on the electrode. The polymer mesh can comprise an inert, non-electroactive polymer, such as, for example but not limited to, polyethylene, polyethylene terephthalate, PVDF, a cellulose derivative, polyimide, or polyether-ether-ketone, whereby the mesh has a porosity between about 50% and 90% and a thickness between about 0.1 micron and about 10 microns. The pores of the inert polymer mesh become filled with the deposited solid polymer electrolyte, and the entire electrode-inert polymer mesh-solid polymer electrolyte layer can be used in the final battery assembly.

Step c: Combining the polymer electrolyte/separator swollen with the organic carbonate liquid and dissociable lithium salt adhered to the anode/current collector with a corresponding cathode/current collector to form a rechargeable lithium ion battery.

In various embodiments, a polymer electrolyte/separator swollen with the organic carbonate liquid and dissociable lithium salt adhered to the cathode/current collector can be combined with the corresponding anode/current collector to form a rechargeable lithium ion battery

In various embodiments, a polymer electrolyte/separator swollen with the organic carbonate liquid and dissociable lithium salt adhered to the cathode/current collector can be combined with a polymer electrolyte/separator swollen with the same or different organic carbonate liquid and dissociable lithium salt adhered to the anode/current collector to form a rechargeable lithium ion battery.

In various embodiments, an additional organic carbonate liquid containing a dissociable lithium salt may be added to the polymer coated cathode/current collector or polymer coated anode/current collector prior to assembling the battery to act as a plasticizer and increase lithium inventory.

In various embodiments, a single substrate can be coated with a cathode on one side and anode on the other side, wherein either one or both electrodes have an adherent polymer electrolyte/separator layer swollen with the organic carbonate liquid and dissociable lithium salt. The cathode-substrate-anode-electrolyte/separator assembly can be stacked between positive and negative terminals to form a high voltage bipolar battery, whereby the voltage depends on the number of stacked layers in the battery. In this aspect the substrate can be a current collector or other solid material that prevents direct contact between the anode and cathode.

Step d: Drying or partial drying of the polymer electrolyte/separator by applying a temperature or vacuum, calendaring, or compression with a porous absorbent fabric.

In accordance with various embodiments, a rechargeable solid-state lithium ion battery can be assembled having a lithium metal anode and a solid polymer electrolyte/separator swollen with an organic carbonate liquid and dissociable lithium salt adhered to its surface. This polymer electrolyte/separator can have a thickness of 0.1-10 microns and can be deposited by submerging clean lithium metal attached to a current collector on one side into a solution of an organic carbonate liquid containing fluorinated ethylene carbonate at a concentration of between 10 ppm to 100,000 ppm, and a concentration of LiTDI of between 0.1 M and 1.5 M. This polymer electrolyte/separator forms on the exposed face of the anode and can be formed by submerging in an inert atmosphere once, or multiple times for a length of time until the desired thickness between 0.1 and 10 microns is achieved. A supporting inert polymer mesh (0.1 to 10 microns thick, 50-90% porosity) can also be added to lend structural support to the polymer electrolyte.

The anode onto which the separator is deposited can be lithium metal, but other anodes could reasonably be used, such as lithiated graphite, other forms of LiC₆, or a lithium ceramic glass (e.g. Li₄Ti₅0i₂, Si(Li_{4,4}Si) or Ge (Li_{4,4}Ge)) bound together with PVDF. The anode can be in the form of a thin metal foil placed on top of a current collector, or lithium filling the pores of an electrically conductive mesh comprising copper, aluminum, or stainless steel. The mesh functions as the current collector and has a porosity of between 25-75%, and a thickness of 5-200 microns.

The anode coated with a solid polymer electrolyte/separator can then be combined with a cathode having 5% conductive carbon additive, 5% PVDF binder, and 90% Li(Ni₁Mn₁Co₁O₂) having a particle size of 20 microns, attached to a metal foil current collector. Other cathodes can reasonably be used, such as LiCoO₂, LiFePO₄, LiMn₂O₄, LiNiO₂, Li₂FePO₄F, Li(LiₐNiₓMn_{y}Co_{z}), or other lithium containing metal oxides of various compositions.

The anode/cathode polymer electrolyte/separator assembly can then be sealed inside a 2032 coin cell under an inert atmosphere for analysis. The cell has an active surface area of 250 mm². The lithium ion battery is charged to 4.2 V and discharged to 3.0 V at a current density of between 300-400 mAh/g. When a coin cell containing the electrolyte/separator adhered to the anode is charged/discharged at 0.33 mA, a voltage drop of between 25-125 mV is observed, indicating an internal resistance of 190-950 ohm-cm at room temperature. Since the anode and cathode contain conductive carbons, they generally have negligible resistances (less than 10 ohm-cm), the measured resistance can be almost entirely attributed to the electrolyte/separator.

In various embodiments, the battery is able to safely operate with solely the polymer electrolyte/separator and without the need for a separate separator component.

The lithium salt in the above described lithium batteries is LiTDI, but in addition to this, other lithium compounds such as lithium perchlorate, lithium triflate, lithium triflimide, lithium hexafluorophosphate, lithium tetrafluoroborate, or other lithium salts soluble in organic substances could equally well have been used in varying amounts. The advantages of the composite electrolyte/separator described above include that the ion conductive but electrically insulating layer may be thinner than if a microporous separator combined with a polymer electrolyte is used. Another advantage is that the porous or microporous inert separator laminate is not required, thereby increasing the conductivity of the electrolyte layer and the current the lithium battery is capable of providing while providing the same or improved mechanical strength. The absence of a traditional separator component simplifies the manufacturing process and allows for cost savings of up to 10%. The advantages of our specific electrolyte system imbue innate flexibility to the polymer electrolyte/separator/SEI that prevents fracture during operation in electric vehicles, and also give self-healing properties to the SEI, effectively preventing dendrite growth that commonly plagues polymer electrolytes. Although the present disclosure has been described with reference to the preferred embodiment, it is to be understood that modifications and variations may be resorted to without departing from the spirit and scope of the invention, as those skilled in the art will readily understand. Such modification and variations are considered to be within the purview and scope of the invention and the appended claims.

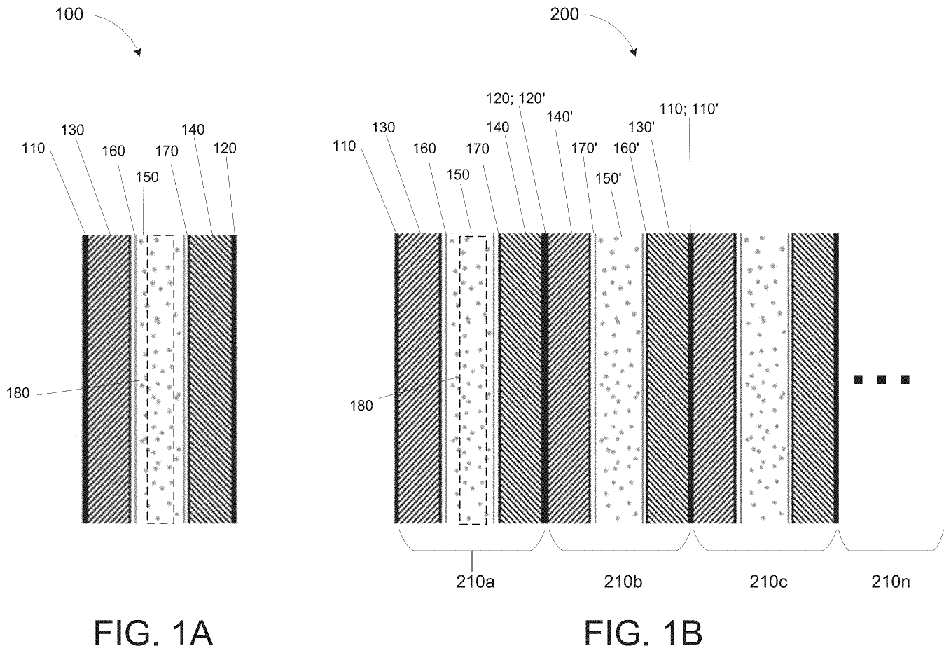

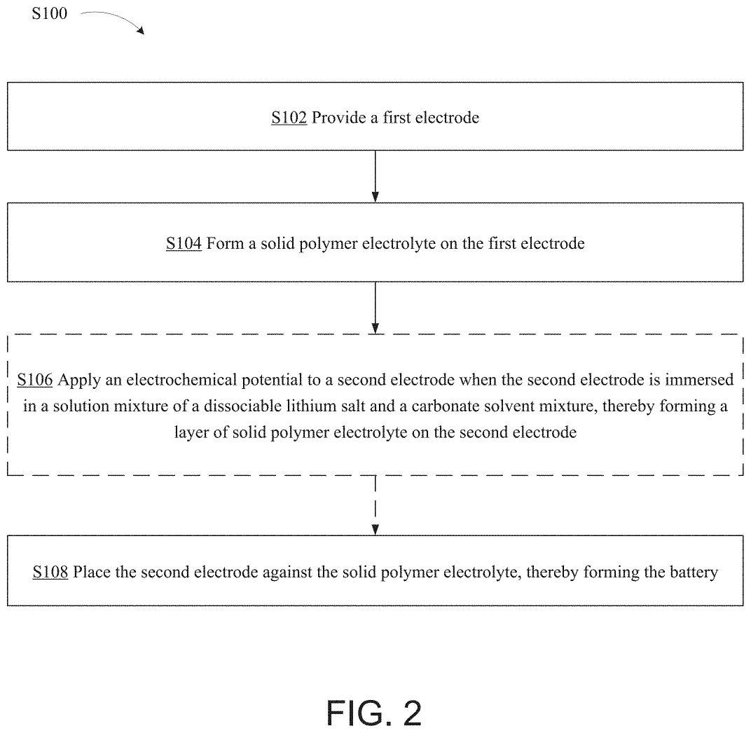

In accordance with various materials, designs, and methods disclosed herein, energy storage devices and methods of preparing the same are further described with respect to FIGS. 1-7.

FIG. 1A illustrates an example embodiment of an electrochemical cell 100, in accordance with various embodiments. In accordance with various embodiments, the electrochemical cell 100 can include a battery, a lithium battery, a lithium ion battery, a solid-state lithium battery, a solid-state lithium ion battery, a lithium metal battery, a lithium polymer battery, or any other devices that utilize electrochemistry of chemical materials.

As illustrated in FIG. 1A, the electrochemical cell 100 includes a first current collector 110 and a second current collector 120. The first current collector 110 is for a first electrode 130 and the second current collector 120 is for a second electrode 140. In various embodiments, the first electrode 130 is an anode and the second electrode 140 is a cathode. In various embodiments, the first electrode 130 is a cathode and the second electrode 140 is an anode.

In various embodiments, the first electrode 130 can include a lithium metal, lithium foil, a treated copper foil, treated copper foil a graphite, a lithiated graphite, LiC₆, a lithium ceramic glass, Li₄Ti₅0i₂, Li_{4,4}Si, or Li_{4,4}Ge bound together with polyvinylidene fluoride (PVDF).

In various embodiments, the second electrode 140 can include a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

As illustrated in FIG. 1A, a layer 150 is disposed between the first electrode 130 and the second electrode 140. In various embodiments, the layer 150 can be referred to as electrolyte 150. In various embodiments, the electrolyte 150 can be a combined polymer electrolyte and separator described herein. In various embodiments, the electrolyte 150 can be a solid electrolyte. In various embodiments, the electrolyte 150 can be a solid polymer electrolyte. In various embodiments, the electrolyte 150 can be a layer of solid electrolyte. In various embodiments, the electrolyte 150 can be a solid layer of electrolyte. In various embodiments, the electrolyte 150 can be a layer of polymer electrolyte. In various embodiments, the electrolyte 150 can be a layer of porous polymer electrolyte.

In various embodiments, the layer 150 can have a thickness ranging between about 0.1 microns and about 50 microns, between about 0.2 microns and about 40 microns, between about 0.3 microns and about 20 microns, between about 0.4 microns and about 10 microns, or between about 0.1 microns and about 10 microns, inclusive of any thickness ranges therebetween.

In various embodiments, the layer 150 can contain a dissociable lithium salt concentration range of about 0.1 M to about 1.5 M, about 0.2 M to about 1.0 M, about 0.3 M to about 0.8 M, about 0.4 M to about 0.5 M, about 0.1 M to about 1.0 M, or about 0.1 M to about 0.5 M, inclusive of any concentration ranges therebetween.

In various embodiments, the layer 150 can be swollen with a mount of about 1 ppm to about 50 wt. % of the layer of an organic carbonate-based liquid as disclosed herein.

As further illustrated in FIG. 1A, the electrochemical cell 100 also includes a first interface 160 that is formed between the first electrode 130 and the layer 150 and a second interface 170 that is formed between the second electrode 140 and the layer 150. The first interface 160 and the second interface 170 are the interfaces between the solid polymer electrolyte/separator and the anode or cathode of the electrochemical cell 100.

In various embodiments, the layer 150 can include a portion of solvent swollen within the layer, wherein, during operation, the portion of swollen solvent reacts with a growing dendrite to form polymers on the dendrite. In various embodiments, the layer 150 can include a fluorinated ethylene carbonate is used as a crosslinking agent, for example, for the solid polymer electrolyte. In various embodiments, the layer 150 can include the solid polymer electrolyte that is polymerized to a surface of the first electrode 130 or second electrode 140. In various embodiments, the layer 150 includes passivating polymer layer that is microporous and comprises self-healing properties as a result of a mixture of dissociable lithium salt, carbonate solvent mixture, and lithium metal surface. In various embodiments, the passivating polymer layer is adherent to the first and/or second electrode and prevents dendrite growth due to its self-healing properties.

In various embodiments, the layer 150 includes a solid polymer electrolyte that comprises a polymer ceramic composite material or one or more ion conducting ceramic or inorganic materials. In various embodiments, the layer 150 can include one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

In various embodiments, the layer 150 includes a solid polymer electrolyte that is capable of growing a passivating polymer layer at an interface (e.g., first interface 160) between the first electrode 130 and the solid polymer electrolyte of the layer 150. In various embodiments, the layer 150 includes a solid polymer electrolyte that is capable of growing a passivating polymer layer at an interface (e.g., the second interface 170) between the second electrode 140 and the solid polymer electrolyte of the layer 150. In various embodiments, the passivating polymer layer is adherent to the first and/or second electrode 130/140 and prevents dendrite growth due to its self-healing properties.

In various embodiments, the layer 150 includes a solid polymer electrolyte that includes a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

In various embodiments, the layer 150 includes a solid layer of electrolyte that includes a microporous polymer swollen with an organic carbonate liquid and a dissociable lithium salt.

In various embodiments, the layer 150 includes a solid layer of electrolyte that is lithium ion conductive and electrically insulating. In various embodiments, the layer 150 includes a solid layer of electrolyte that is grown directly on the first electrode 130 (or anode). In various embodiments, the layer 150 includes a solid layer of electrolyte that is grown directly on the second electrode 140 (or cathode).

In various embodiments, the layer 150 includes a solid layer of electrolyte that includes a portion of solvent swollen within the solid polymer electrolyte, wherein the portion of swollen solvent reacts with a growing dendrite to form polymers on the dendrite (e.g., self-healing). In various embodiments, the layer 150 includes a fluorinated ethylene carbonate that is used as a crosslinking agent for the solid polymer electrolyte. In various embodiments, the layer 150 includes a polymer including a polycarbonate or a carbonate containing polymer with a monomer composition determined by a composition of organic carbonate liquid mixture. In various embodiments, the layer 150 includes a solid layer of electrolyte that is polymerized to the surface of the first electrode 130 and/or the second electrode 140.

In various embodiments, the layer 150 includes a polymer that adheres to the first electrode 130 and/or the second electrode 140 via a chemical reduction reaction of lithium 2-Trifluoromethyl-4,5-Dicyanoimidazolide, which initiates a polymerization of carbonate liquids on the surface of the first electrode 130 and/or the second electrode 140.

In various embodiments, the layer 150 includes at least a portion of the solid polymer electrolyte that is porous. In various embodiments, the porous portion of the solid polymer electrolyte are swollen with an organic liquid and a dissociable lithium salt. In various embodiments, the dissociable lithium salt dissolved in an organic liquid can include one or more of lithium 2-Trifluoromethyl-4,5-Dicyanoimidazolide, lithium hexafluorophosphate, lithium triflate, lithium triflimide, lithium perchlorate, lithium tetrafluoroborate, or lithium bistriflimide.

In various embodiments, the layer 150 includes a microporous polymer that is deposited or adhered to at least one face of at least one electrode by electrodeposition, chemical reduction, electrochemical reduction, or immersion of the electrode in a corresponding solution containing organic carbonates and a dissociable lithium salt. In various embodiments, the layer 150 includes a microporous polymer that possesses self-healing properties as a result of the specific mixture of dissociable lithium salt, carbonate solvent mixture, and lithium metal surface. In various embodiments, the layer 150 includes a microporous polymer that prevents dendrite growth due to its self-healing properties. In various embodiments, the layer 150 includes a microporous polymer that resists fracture and cracking as a result of vibrational and shock forces typically seen in battery use in electric vehicles.

In various embodiments, the layer 150 includes a microstructure of the polymer that is determined via a ratio between fluorinated ethylene carbonate and cyclic carbonate solvent. In various embodiments, the chemical and/or electronic properties of the polymer are determined via a ratio between fluorinated ethylene carbonate and cyclic carbonate solvent. In various embodiments, the ratio between fluorinated ethylene carbonate and cyclic carbonate solvent can range from about 5% to about 20%, from about 5% to about 15%, from about 5% to about 10%, from about 10% to about 20%, from about 10% to about 15%, or from about 15% to about 20%, inclusive of all ratio ranges therebetween.

In various embodiments, the layer 150 includes a structural support 180. In various embodiments, the structural support 180 can include an inert polymer mesh. In various embodiments, the inert polymer mesh can include polyethylene, polyethylene terephthalate, PVDF, a cellulose derivative, polyimide, or polyether-ether-ketone.

In various embodiments, the inert polymer mesh can have a porosity between 50% and 90% and a thickness between 0.1 micron and 10 microns. In various embodiments, the inert structurally supporting mesh is placed on the electrode prior to deposition of the solid polymer electrolyte.

In various embodiments, the first current collector 110 (e.g., anode) can include a metal mesh made of copper, aluminum, or stainless steel. In various embodiments, the first current collector 110 has a thickness of about 5 microns to about 200 microns. In various embodiments, the first current collector 110 (e.g., anode) includes a porous mesh comprising pores within the anode current collector and wherein a porosity of the anode current collector ranges from 25% to 75%. In various embodiments, the first current collector 110 (e.g., anode) includes pores that are filled or substantially filled with lithium when the battery is charged. In various embodiments, the first current collector 110 (e.g., anode) includes pores that lector are devoid or substantially devoid of lithium when the battery is discharged. In various embodiments, the first current collector 110 (e.g., anode) includes a metal mesh filled with lithium metal does not change volume as the battery charges or discharges.

FIG. 1B illustrates an example embodiment of a bipolar electrochemical cell 200, in accordance with various embodiments. As illustrated in FIG. 1B, the bipolar electrochemical cell 200 can be built by stacking two or more of the electrochemical cell 100 of FIG. 1A back to back to one another. In accordance with various embodiments, since the bipolar electrochemical cell 200 can be built by stacking two or more of the electrochemical cell 100 in a bipolar cell arrangement, each and every component of the bipolar electrochemical cell 200 can include respective components of the electrochemical cell 100, which are described respect to FIG. 1A, and thus, the various components of the bipolar electrochemical cell 200 are identical, similar or substantially similar to those of the electrochemical cell 100 and will not be described in further detail.

As illustrated in FIG. 1B, the bipolar electrochemical cell 200 can include a first cell 210a, a second cell 210b, a third cell 210b, and so on and so forth, to 210n. Each of the cells 210a . . . 210b, can include a first current collector 110 and a second current collector 120, a first electrode 130 and a second electrode 140, a layer 150, a first interface 160 that is formed between the first electrode 130 and the layer 150, and a second interface 170 that is formed between the second electrode 140 and the layer 150. The bipolar electrochemical cell 200 illustrated in FIG. 1B includes, for example, the first cell 210a and the second cell 210b that are disposed back to back, whereby the second current collector 120 serves as a common current collector, for example, the second current collector 120 of the first cell 210a and the second current collector 120′ of the adjacent second cell 210b. As illustrated, the second cell 210b includes a first electrode 130′ and a second electrode 140′, a layer 150′, a first interface 160′ that is formed between the first electrode 130′ and the layer 150′, and a second interface 170′ that is formed between the second electrode 140′ and the layer 150′. Similarly, the third cell 210b can include similar layers of materials but may be in the same reverse order as in the first cell 210a but reverse order as in the second cell 210c. Accordingly, the common current collectors 110, 110′, 120, and 120′ can form respective negative and positive terminals of the bipolar battery stack of the bipolar electrochemical cell 200 of FIG. 1B.

In various embodiments, the bipolar electrochemical cell 200 can be constructed into a high voltage bipolar lithium ion battery having the combined layers and components as disclosed herein with respect to FIGS. 1A and 1B. In various embodiments, the voltage of this battery can be varied by changing the number of cells in the stack.

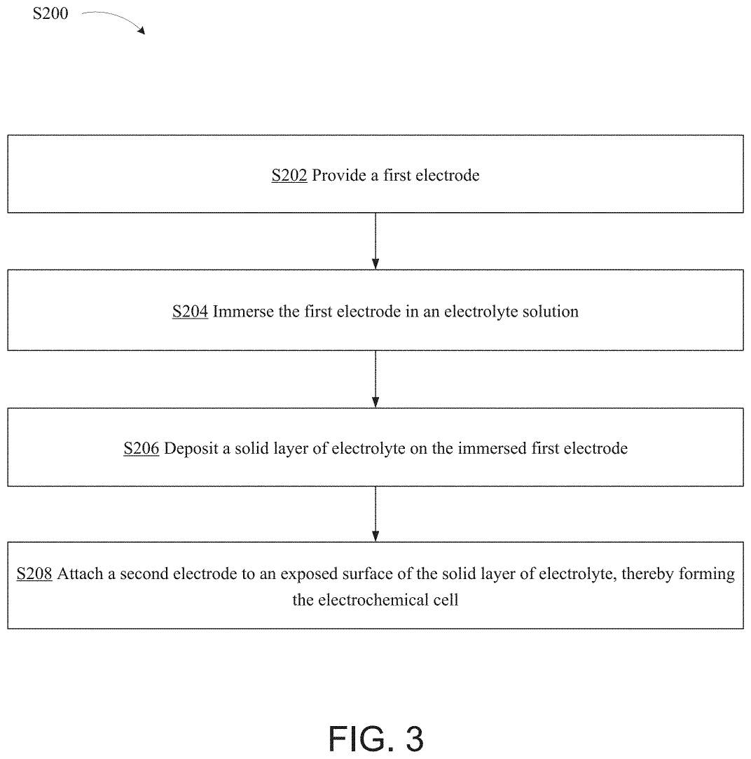

FIGS. 2-6 illustrate various example methods of preparing an electrochemical cell, in accordance with various embodiments.

FIG. 2 illustrates a method S100 of preparing a lithium battery, in accordance with various embodiments. The method S100 includes, at step S102, providing a first electrode; at step S104, forming a solid polymer electrolyte on the first electrode; optionally at step S106, applying an electrochemical potential to the second electrode when the second electrode is immersed in a solution mixture of a dissociable lithium salt and a carbonate solvent mixture, thereby forming a layer of solid polymer electrolyte on the second electrode; and at step S108, placing a second electrode against the solid polymer electrolyte, thereby forming the battery. In various embodiments, during operation, the solid polymer electrolyte is capable of growing a passivating polymer layer at an interface between the first electrode and the solid polymer electrolyte, as disclosed herein.

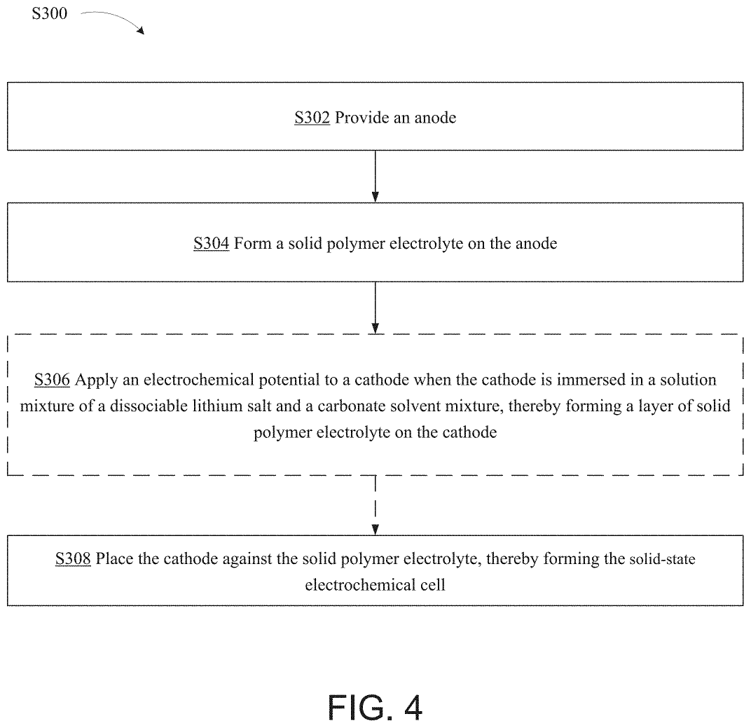

FIG. 3 illustrates a method S200 of preparing an electrochemical cell, in accordance with various embodiments. The method S200 includes, at step S202, providing a first electrode; at step S204, immersing the first electrode in an electrolyte solution; at step S206, depositing a solid layer of electrolyte on the immersed first electrode; and at step S208, attaching a second electrode to an exposed surface of the solid layer of electrolyte, thereby forming the electrochemical cell, as disclosed herein.

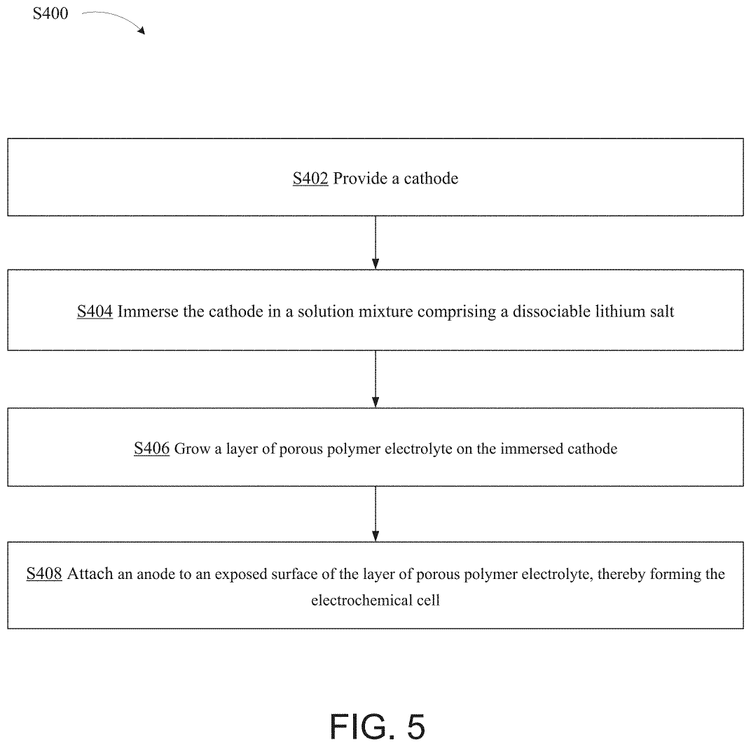

FIG. 4 illustrates a method S300 of preparing a solid-state electrochemical cell, in accordance with various embodiments. The method S300 includes, at step 302, providing an anode; at step S304, forming a solid polymer electrolyte on the anode; optionally at step S306, applying an electrochemical potential to a cathode when the cathode is immersed in a solution mixture of a dissociable lithium salt and a carbonate solvent mixture, thereby forming a layer of solid polymer electrolyte on the cathode; and at step S308, placing the cathode against the solid polymer electrolyte, thereby forming the solid-state electrochemical cell, as disclosed herein. In various embodiments, during operation, the solid polymer electrolyte is capable of growing a passivating polymer layer at an interface between the anode and the solid polymer electrolyte.

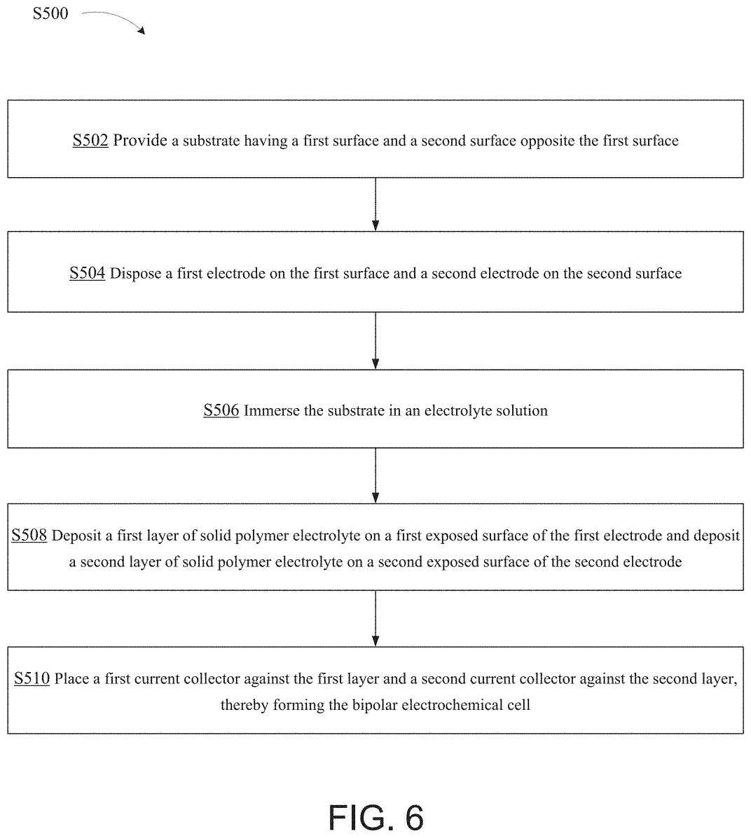

FIG. 5 illustrates a method S400 of preparing an electrochemical cell, in accordance with various embodiments. The method S400 includes, at step S402, providing a cathode; at step S404, immersing the cathode in a solution mixture comprising a dissociable lithium salt; at step S406, growing a layer of porous polymer electrolyte on the immersed cathode; and at step S408, attaching an anode to an exposed surface of the layer of porous polymer electrolyte, thereby forming the electrochemical cell, as disclosed herein.

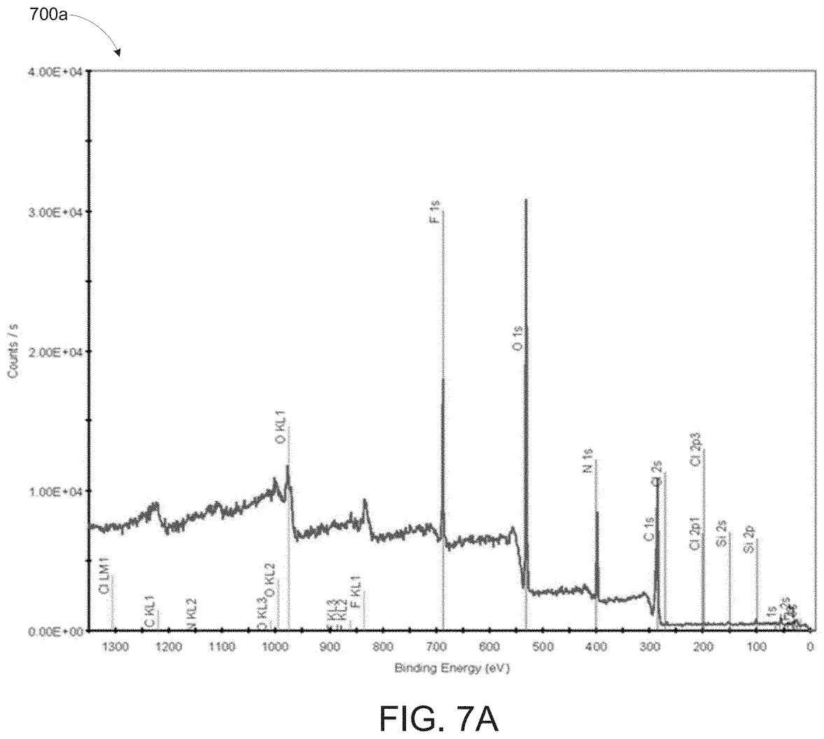

FIG. 6 illustrates a method S500 of preparing a bipolar electrochemical cell, in accordance with various embodiments. The method S500 includes at step S502, providing a substrate having a first surface and a second surface opposite the first surface; at step S504, disposing a first electrode on the first surface and a second electrode on the second surface; at step S506, immersing the substrate in an electrolyte solution; at step S508, depositing a first layer of solid polymer electrolyte on a first exposed surface of the first electrode and depositing a second layer of solid polymer electrolyte on a second exposed surface of the second electrode; and at step S510, placing a first current collector against the first layer and a second current collector against the second layer, thereby forming the bipolar electrochemical cell, as disclosed herein.

In accordance with various embodiments of the methods S100-S500, the first electrode or anode includes a lithium metal, lithium foil, a treated copper foil, a graphite, a lithiated graphite, LiC₆, a lithium ceramic glass, Li₄Ti₅0i₂, Li_{4,4}Si, or Li_{4,4}Ge bound together with polyvinylidene fluoride (PVDF). In accordance with various embodiments of the methods S100-S500, the second electrode or cathode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

In accordance with various embodiments of the methods S100-S500, the solid polymer electrolyte is formed on the first electrode or anode via an in-situ chemical or electrochemical deposition process.

In accordance with various embodiments of the methods S100-S500, the solid polymer electrolyte comprises a structural support. In accordance with various embodiments of the methods S100-S500, the structural support of the solid polymer electrolyte comprises an inert polymer mesh. In accordance with various embodiments of the methods S100-S500, the inert polymer mesh comprises polyethylene, polyethylene terephthalate, PVDF, a cellulose derivative, polyimide, or polyether-ether-ketone. In accordance with various embodiments of the methods S100-S500, the inert polymer mesh has a porosity between 50% and 90% and a thickness between 0.1 micron and 10 microns. In accordance with various embodiments of the methods S100-S500, the inert structurally supporting mesh is placed on the electrode prior to deposition of the solid polymer electrolyte.

In accordance with various embodiments of the methods S100-S500, the growing of the solid polymer electrolyte on the second electrode or cathode comprises applying an electrochemical potential to the second electrode or cathode when the second electrode or cathode is immersed in the solution mixture.

In accordance with various embodiments of the methods S100-S500, the deposition process occurs via a chemical or electrochemical reaction of a lithium-TDI salt and a cyclic carbonate solvent (to form a polycarbonate off of the first or second electrode).

In accordance with various embodiments of the methods S100-S500, the solid polymer electrolyte has a thickness ranging between 0.1 microns to 10 microns. In accordance with various embodiments of the methods S100-S500, the solid polymer electrolyte that is lithium ion conductive and electrically insulating.

In accordance with various embodiments of the methods S100-S500, the solid polymer electrolyte is grown directly on the first electrode or anode. In accordance with various embodiments of the methods S100-S500, the solid polymer electrolyte is grown directly on the second electrode or cathode. In accordance with various embodiments of the methods S100-S500, the solid polymer electrolyte comprises a portion of solvent swollen within the solid polymer electrolyte, wherein the portion of swollen solvent reacts with a growing dendrite to form polymers on the dendrite.

In accordance with various embodiments of the methods S100-S500, a fluorinated ethylene carbonate is used as a crosslinking agent for the solid polymer electrolyte. In accordance with various embodiments of the methods S100-S500, the polymer is a polycarbonate or a carbonate containing polymer with a monomer composition determined by a composition of organic carbonate liquid mixture. In accordance with various embodiments of the methods S100-S500, the solid polymer electrolyte is polymerized to the surface of the first or second electrode. In accordance with various embodiments of the methods S100-S500, the polymer adheres to the anode via a chemical reduction reaction of lithium 2-Trifluoromethyl-4,5-Dicyanoimidazolide, which initiates a polymerization of carbonate liquids on the surface of the anode. In accordance with various embodiments of the methods S100-S500, the polymer is adhered to the cathode via an electrochemical reduction reaction of lithium 2-Trifluoromethyl-4,5-Dicyanoimidazolide, which initiates the polymerization of the carbonate liquid onto the surface of the cathode.

In accordance with various embodiments of the methods S100-S500, the adherent microporous polymer is deposited or adhered to at least one face of at least one electrode by electrodeposition, chemical reduction, electrochemical reduction, or immersion of the electrode in a corresponding solution containing organic carbonates and a dissociable lithium salt.

In accordance with various embodiments of the methods S100-S500, the microporous polymer comprises self-healing properties as a result of the specific mixture of dissociable lithium salt, carbonate solvent mixture, and lithium metal surface. In accordance with various embodiments of the methods S100-S500, the adherent microporous polymer prevents dendrite growth due to its self-healing properties. In accordance with various embodiments of the methods S100-S500, the adherent microporous polymer resists fracture and cracking as a result of vibrational and shock forces typically seen in battery use in electric vehicles. In accordance with various embodiments of the methods S100-S500, a microstructure of the polymer is determined via a ratio between fluorinated ethylene carbonate and cyclic carbonate solvent.

In accordance with various embodiments of the methods S100-S500, chemical and/or electronic properties of the polymer are determined via a ratio between fluorinated ethylene carbonate and cyclic carbonate solvent. In various embodiments, the ratio between fluorinated ethylene carbonate and cyclic carbonate solvent can range from about 5% to about 20%, from about 5% to about 15%, from about 5% to about 10%, from about 10% to about 20%, from about 10% to about 15%, or from about 15% to about 20%, inclusive of all ratio ranges therebetween.

In accordance with various embodiments of the methods S100-S500, growing the solid polymer electrolyte on the anode occurs via an electrochemical reaction of a lithium TDI salt and a cyclic carbonate solvent. In accordance with various embodiments of the methods S100-S500, the solution mixture is an electrolyte solution comprising one or more organic carbonates containing a dissociable lithium salt in a concentration between 0.1 M and 1.5 M. In accordance with various embodiments of the methods S100-S500, a concentration of lithium 2-Trifluoromethyl-4,5-Dicyanoimidazolide (LiTDI) is between 0.1 M and 1.5 M.

In accordance with various embodiments of the methods S100-S500, the one or more organic carbonates comprise ethylene carbonate, dimethyl carbonate, ethyl-methyl carbonate, propylene carbonate, fluorinated ethylene carbonate, or a mixture thereof. In accordance with various embodiments of the methods S100-S500, the one or more organic carbonates comprise fluorinated ethylene carbonate in a concentration of between 10 ppm and 100,000 ppm.

In accordance with various embodiments of the methods S100-S500, at least a portion of the solid polymer electrolyte comprises a porous portion. In accordance with various embodiments of the methods S100-S500, the porous portion of the solid polymer electrolyte are swollen with an organic liquid and a dissociable lithium salt.

In accordance with various embodiments of the methods S100-S500, the dissociable lithium salt dissolved in an organic liquid comprises one or more of lithium 2-Trifluoromethyl-4,5-Dicyanoimidazolide, lithium hexafluorophosphate, lithium triflate, lithium triflimide, lithium perchlorate, lithium tetrafluoroborate, or lithium bistriflimide.

In accordance with various embodiments of the methods S100-S500, the anode current collector comprises a metal mesh made of copper, aluminum, or stainless steel. In accordance with various embodiments of the methods S100-S500, the anode current collector has a thickness of about 5 microns to about 200 microns. In accordance with various embodiments of the methods S100-S500, the anode current collector is a porous mesh comprising pores within the anode current collector and wherein a porosity of the anode current collector ranges from 25% to 75%. In accordance with various embodiments of the methods S100-S500, the pores of the anode current collector are filled or substantially filled with lithium when the battery is charged. In accordance with various embodiments of the methods S100-S500, the pores of the anode current collector are devoid or substantially devoid of lithium when the battery is discharged. In accordance with various embodiments of the methods S100-S500, the anode comprising a metal mesh filled with lithium metal does not change volume as the battery charges or discharges. In accordance with various embodiments of the methods S100-S500, a substrate used in the electrochemical cell is electrically conducting. In various embodiments, the substrate comprises a non-electrically conducting material.

### EXAMPLES

A non-limiting example includes a polymer electrolyte/separator for a rechargeable solid-state lithium ion battery comprising an adherent microporous polymer layer wherein the pores are swollen with an organic liquid and a dissociable lithium salt, and the polymer is adhered to an electrode, and the polymer acts as both the ion conducting portion of the electrolyte as well as the electronically insulating and mechanically robust separator component.

A non-limiting example includes a polymer electrolyte/separator for a rechargeable solid-state lithium ion battery, wherein the solid polymer electrolyte is formed around an inert polymer mesh (e.g. polyethylene, polyethylene terephthalate, PVDF, a cellulose derivative, polyimide, or polyether-ether-ketone) whereby the mesh has a porosity between about 50% and about 90% and a thickness between about 0.1 micron and about 10 microns, inclusive of any thickness values or range of thickness values therebetween.

A non-limiting example includes a composite electrolyte/separator for a rechargeable solid-state lithium ion battery, wherein the organic liquid is an organic carbonate or mixture of organic carbonates chosen from ethylene carbonate, dimethyl carbonate, ethyl methyl carbonate, fluorinated ethylene carbonate, or some other carbonate in the class of organic carbonate liquids.

A non-limiting example includes a composite electrolyte/separator for a rechargeable solid-state lithium ion battery, wherein the organic carbonate liquid mixture contains fluorinated ethylene carbonate in a concentration of between 10 ppm and 100,000 ppm.

A non-limiting example includes a composite electrolyte/separator for a rechargeable solid-state lithium ion battery, wherein the dissociable lithium salt dissolved in the organic liquid is lithium 2-Trifluoromethyl-4,5-Dicyanoimidazolide, and may or may not contain additional lithium salts such as lithium hexafluorophosphate, lithium triflate, lithium triflimide, lithium perchlorate, lithium tetrafluoroborate, or another soluble lithium salt.

A non-limiting example includes a composite electrolyte/separator for a rechargeable solid-state lithium ion battery, wherein lithium 2-Trifluoromethyl-4,5-Dicyanoimidazolide is present in a concentration of between 0.1 M and 1.5 M.

A non-limiting example includes a composite electrolyte/separator for a rechargeable solid-state lithium ion battery, wherein the polymer is a polycarbonate, or carbonate containing polymer with a monomer composition corresponding to the composition of the organic carbonate liquid mixture.

A non-limiting example includes a polymer electrolyte/separator for a rechargeable solid-state lithium ion battery, wherein the polymer is adhered to the anode via a chemical reduction reaction of lithium 2-Trifluoromethyl-4,5-Dicyanoimidazolide, which initiates a polymerization of carbonate liquids on the surface of the anode.

A non-limiting example includes a polymer electrolyte/separator for a rechargeable solid-state lithium ion battery, wherein the polymer is adhered to the cathode via an electrochemical reduction reaction of lithium 2-Trifluoromethyl-4,5-Dicyanoimidazolide, which initiates the polymerization of the carbonate liquid onto the surface of the cathode.

A non-limiting example includes a polymer electrolyte/separator for a rechargeable solid-state lithium ion battery, wherein the adherent microporous polymer is deposited or adhered to at least one face of at least one electrode by electrodeposition, chemical reduction, electrochemical reduction, or immersion of the electrode in a corresponding solution containing organic carbonates and a dissociable lithium salt.

A non-limiting example includes a polymer electrolyte/separator for a rechargeable solid-state lithium ion battery, wherein the adherent microporous polymer contains self-healing properties as a result of the specific mixture of dissociable lithium salt, carbonate solvent mixture, and lithium metal surface or other reducing environment provided by the anode.

A non-limiting example includes a polymer electrolyte/separator for a rechargeable solid-state lithium ion battery, wherein the adherent microporous polymer prevents dendrite growth due to its self-healing properties.

A non-limiting example includes a polymer electrolyte/separator for a rechargeable solid-state lithium ion battery, wherein the adherent microporous polymer resists fracture and cracking as a result of vibrational and shock forces typically seen in battery use in electric vehicles.

A non-limiting example includes a rechargeable lithium ion battery comprising: a positive electrode, a negative electrode, and a polymer electrolyte/separator comprising a microporous polymer layer adhered to at least one of the electrodes of the battery that functions as the ion conductive component and the electrically insulating component of the battery, wherein the anode current collector may be an electrically conductive mesh comprising copper, aluminum, or stainless steel. The metal mesh functions as the current collector and has a porosity of between about 25% and about 75%, and a thickness between about 5 microns and about 200 microns.

A non-limiting example includes a rechargeable lithium ion battery comprising: a positive electrode, a negative electrode, and a polymer electrolyte/separator comprising a microporous polymer layer adhered to at least one of the electrodes of the battery that functions as the ion conductive component and the electrically insulating component of the battery, wherein the polymer is swollen with an organic carbonate liquid and a dissociable lithium salt. The form of this battery can be a rechargeable single cell or bipolar stack of rechargeable cells.

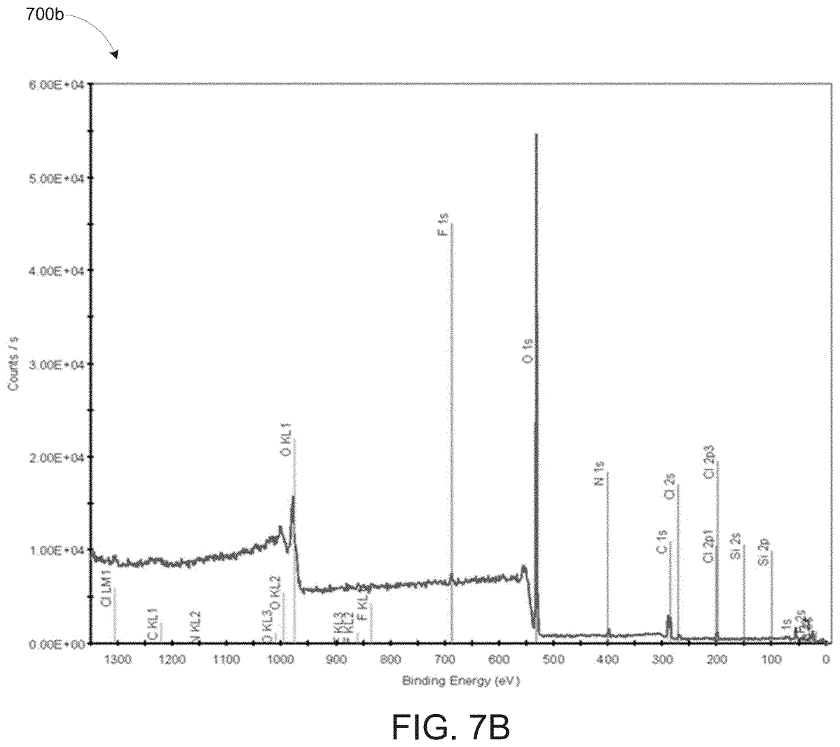

FIGS. 7A and 7B illustrate plots 700a and 700b, respectively, showing X-ray photoelectron spectroscopy (XPS) results, in accordance with various embodiments. FIG. 7A shows XPS results of a treated lithium sample and FIG. 7B shows XPS results of untreated lithium sample. The XPS data of the two samples are further tabulated and displayed in Table 1, as shown below.

TABLE 1

| | Treated Li | Untreated Li |
|---|---|---|
| Name | Atomic % | Atomic % |
| Li | 17.81 | 41.40 |
| Si | 0.79 | 0.30 |
| Cl | 0.26 | 0.72 |
| F | 8.88 | 1.27 |
| C | 35.73 | 11.81 |
| N | 8.38 | 1.11 |
| O | 28.15 | 43.39 |

As shows in Table 1, treated lithium surface, as shown in FIG. 7A has a significantly higher percentage of carbon and fluorine as compared to untreated Li sample (FIG. 7B). This indicates that a polymer layer is formed and the surface is rich in fluorine, which indicates a presence of LiF.

### Recitation of Embodiments

Embodiment 1. A method of preparing an electrochemical cell, comprising: providing a first electrode; immersing the first electrode in an electrolyte solution; depositing a solid layer of electrolyte on the immersed first electrode; and attaching a second electrode to an exposed surface of the solid layer of electrolyte, thereby forming the electrochemical cell.

Embodiment 2. A method of preparing a battery, comprising: providing a first electrode; forming a solid polymer electrolyte on the first electrode; and placing a second electrode against the solid polymer electrolyte, thereby forming the battery, wherein, during operation, the solid polymer electrolyte is capable of growing a passivating polymer layer at an interface between the first electrode and the solid polymer electrolyte. In various embodiments, the battery is a solid-state lithium ion battery.

Embodiment 3. A method of preparing a solid-state electrochemical cell, comprising: providing an anode; forming a solid polymer electrolyte on the anode; and placing a cathode against the solid polymer electrolyte, thereby forming the solid-state electrochemical cell, wherein, during operation, the solid polymer electrolyte is capable of growing a passivating polymer layer at an interface between the anode and the solid polymer electrolyte.

Embodiment 4. A method of preparing an electrochemical cell, comprising: providing a cathode; immersing the cathode in a solution mixture comprising a dissociable lithium salt; growing a layer of porous polymer electrolyte on the immersed cathode; and attaching an anode to an exposed surface of the layer of porous polymer electrolyte, thereby forming the electrochemical cell.

Embodiment 5. A method of preparing a bipolar electrochemical cell, comprising: providing a substrate having a first surface and a second surface opposite the first surface; disposing a first electrode on the first surface and a second electrode on the second surface;

immersing the substrate in an electrolyte solution; depositing a first layer of solid polymer electrolyte on a first exposed surface of the first electrode and depositing a second layer of solid polymer electrolyte on a second exposed surface of the second electrode; and placing a first current collector against the first layer and a second current collector against the second layer, thereby forming the bipolar electrochemical cell.

Embodiment 6. The method of Embodiment 5, wherein the depositing of the first layer and the depositing of the second layer occurs concurrently.

Embodiment 7. The method of any one of the preceding Embodiments, wherein the first electrode or anode comprises a lithium metal, lithium foil, a treated copper foil, a graphite, a lithiated graphite, LiC₆, a lithium ceramic glass, Li₄Ti₅0i₂, Li_{4,4}Si, or Li_{4,4}Ge bound together with polyvinylidene fluoride (PVDF).

Embodiment 8. The method of any one of the preceding Embodiments, wherein the second electrode or cathode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

Embodiment 9. The method of any one of the preceding Embodiments, wherein the solid polymer electrolyte is formed on the first electrode or anode via an in-situ chemical or electrochemical deposition process.

Embodiment 10. The method of any one of the preceding Embodiments, wherein the solid polymer electrolyte comprises a structural support.

Embodiment 11. The method of any one of the preceding Embodiments, wherein the structural support of the solid polymer electrolyte comprises an inert polymer mesh.

Embodiment 12. The method of any one of the preceding Embodiments, wherein the inert polymer mesh comprises polyethylene, polyethylene terephthalate, PVDF, a cellulose derivative, polyimide, or polyether-ether-ketone.

Embodiment 13. The method of any one of the preceding Embodiments, wherein the inert polymer mesh has a porosity between 50% and 90% and a thickness between 0.1 micron and 10 microns.

Embodiment 14. The method of any one of the preceding Embodiments, wherein the inert structurally supporting mesh is placed on the electrode prior to deposition of the solid polymer electrolyte.

Embodiment 15. The method of any one of the preceding Embodiments, wherein the growing of the solid polymer electrolyte on the second electrode or cathode comprises applying an electrochemical potential to the second electrode or cathode when the second electrode or cathode is immersed in the solution mixture.

Embodiment 16. The method of any one of the preceding Embodiments, wherein the deposition process occurs via a chemical or electrochemical reaction of a lithium-TDI salt and a cyclic carbonate solvent (to form a polycarbonate off of the first or second electrode).

Embodiment 17. The method of any one of the preceding Embodiments, wherein the solid polymer electrolyte has a thickness ranging between 0.1 microns to 10 microns.

Embodiment 18. The method of any one of the preceding Embodiments, wherein the solid polymer electrolyte that is lithium ion conductive and electrically insulating.

Embodiment 19. The method of any one of the preceding Embodiments, wherein the solid polymer electrolyte is grown directly on the first electrode or anode.

Embodiment 20. The method of any one of the preceding Embodiments, wherein the solid polymer electrolyte is grown directly on the second electrode or cathode.

Embodiment 21. The method of any one of the preceding Embodiments, wherein the solid polymer electrolyte comprises a portion of solvent swollen within the solid polymer electrolyte, wherein the portion of swollen solvent reacts with a growing dendrite to form polymers on the dendrite (SELF-HEALING).

Embodiment 22. The method of any one of the preceding Embodiments, wherein a fluorinated ethylene carbonate is used as a crosslinking agent for the solid polymer electrolyte.

Embodiment 23. The method of any one of the preceding Embodiments, wherein the polymer is a polycarbonate or a carbonate containing polymer with a monomer composition determined by a composition of organic carbonate liquid mixture.

Embodiment 24. The method of any one of the preceding Embodiments, wherein the solid polymer electrolyte is polymerized to the surface of the first or second electrode.

Embodiment 25. The method of any one of the preceding Embodiments, wherein the polymer adheres to the anode via a chemical reduction reaction of lithium 2-Trifluoromethyl-4,5-Dicyanoimidazolide, which initiates a polymerization of carbonate liquids on the surface of the anode.

Embodiment 26. The method of any one of the preceding Embodiments, wherein the polymer is adhered to the cathode via an electrochemical reduction reaction of lithium 2-Trifluoromethyl-4,5-Dicyanoimidazolide, which initiates the polymerization of the carbonate liquid onto the surface of the cathode.

Embodiment 27. The method of any one of the preceding Embodiments, wherein the adherent microporous polymer is deposited or adhered to at least one face of at least one electrode by electrodeposition, chemical reduction, electrochemical reduction, or immersion of the electrode in a corresponding solution containing organic carbonates and a dissociable lithium salt.

Embodiment 28. The method of any one of the preceding Embodiments, wherein the microporous polymer comprises self-healing properties as a result of the specific mixture of dissociable lithium salt, carbonate solvent mixture, and lithium metal surface.

Embodiment 29. The method of any one of the preceding Embodiments, wherein the adherent microporous polymer prevents dendrite growth due to its self-healing properties.

Embodiment 30. The method of any one of the preceding Embodiments, wherein the adherent microporous polymer resists fracture and cracking as a result of vibrational and shock forces typically seen in battery use in electric vehicles.

Embodiment 31. The method of any one of the preceding Embodiments, wherein microstructure of the polymer is determined via a ratio between fluorinated ethylene carbonate and cyclic carbonate solvent.

Embodiment 32. The method of any one of the preceding Embodiments, wherein chemical and/or electronic properties of the polymer are determined via a ratio between fluorinated ethylene carbonate and cyclic carbonate solvent.

Embodiment 33. The method of any one of the preceding Embodiments, wherein growing the solid polymer electrolyte on the anode occurs via an electrochemical reaction of a lithium TDI salt and a cyclic carbonate solvent.

Embodiment 34. The method of any one of the preceding Embodiments, wherein the solution mixture is an electrolyte solution comprising one or more organic carbonates containing a dissociable lithium salt in a concentration between 0.1 M and 1.5 M.

Embodiment 35. The method of any one of the preceding Embodiments, wherein a concentration of lithium 2-Trifluoromethyl-4,5-Dicyanoimidazolide (LiTDI) is between 0.1 M and 1.5 M.

Embodiment 36. The method of any one of the preceding Embodiments, wherein the one or more organic carbonates comprise ethylene carbonate, dimethyl carbonate, ethyl-methyl carbonate, propylene carbonate, fluorinated ethylene carbonate, or a mixture thereof.

Embodiment 37. The method of any one of the preceding Embodiments, wherein the one or more organic carbonates comprise fluorinated ethylene carbonate in a concentration of between 10 ppm and 100,000 ppm.

Embodiment 38. The method of any one of the preceding Embodiments, wherein at least a portion of the solid polymer electrolyte comprises a porous portion.

Embodiment 39. The method of any one of the preceding Embodiments, wherein the porous portion of the solid polymer electrolyte are swollen with an organic liquid and a dissociable lithium salt.

Embodiment 40. The method of any one of the preceding Embodiments, wherein the dissociable lithium salt dissolved in an organic liquid comprises one or more of lithium 2-Trifluoromethyl-4,5-Dicyanoimidazolide, lithium hexafluorophosphate, lithium triflate, lithium triflimide, lithium perchlorate, lithium tetrafluoroborate, or lithium bistriflimide.

Embodiment 41. The method of any one of the preceding Embodiments, wherein the anode current collector comprises a metal mesh made of copper, aluminum, or stainless steel.

Embodiment 42. The method of any one of the preceding Embodiments, wherein the anode current collector has a thickness of about 5 microns to about 200 microns.

Embodiment 43. The method of any one of the preceding Embodiments, wherein the anode current collector is a porous mesh comprising pores within the anode current collector and wherein a porosity of the anode current collector ranges from 25% to 75%.

Embodiment 44. The method of any one of the preceding Embodiments, wherein the pores of the anode current collector are filled or substantially filled with lithium when the battery is charged.

Embodiment 45. The method of any one of the preceding Embodiments, wherein the pores of the anode current collector are devoid or substantially devoid of lithium when the battery is discharged.

Embodiment 46. The method of any one of the preceding Embodiments, wherein the anode comprising a metal mesh filled with lithium metal does not change volume as the battery charges or discharges.

Embodiment 47. The method of any one of the preceding Embodiments, wherein the substrate is electrically conducting.

Embodiment 48. The method of any one of the preceding Embodiments, wherein the substrate comprises a non-electrically conducting material.

Embodiment 49. An electrochemical cell comprising; a first electrode having a solid polymer electrolyte deposited thereon, the solid polymer electrolyte comprising a microporous polymer swollen with an organic carbonate liquid and a dissociable lithium salt; and a second electrode.

Embodiment 50. A bipolar electrochemical cell comprising; a substrate having a first surface and a second surface opposite the first surface; a first electrode disposed on the first surface, the first electrode having a first layer of solid polymer electrolyte deposited on a side of the first electrode opposite the substrate; a second electrode disposed on the second surface, the second electrode having a second layer of solid polymer electrolyte deposited on a side of the second electrode opposite the substrate, wherein the first layer and the second layer of solid polymer electrolytes comprise a microporous polymer swollen with an organic carbonate liquid and a dissociable lithium salt; a third electrode disposed on the first layer of solid polymer electrolyte; and a fourth electrode disposed on the second layer of solid polymer electrolyte.

Embodiment 51. The electrochemical cell of Embodiments 49 or 50, wherein the first electrode or anode comprises a lithium metal, lithium foil, a treated copper foil, a graphite, a lithiated graphite, LiC₆, a lithium ceramic glass, Li₄Ti₅0i₂, Li_{4,4}Si, or Li_{4,4}Ge bound together with polyvinylidene fluoride (PVDF).

Embodiment 52. The electrochemical cell of any one of Embodiments 49-51, wherein the second electrode or cathode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

Embodiment 53. The electrochemical cell of any one of Embodiments 49-52, wherein the solid polymer electrolyte is formed on the first electrode or anode via an in-situ chemical or electrochemical deposition process.

Embodiment 54. The electrochemical cell of any one of Embodiments 49-53, wherein the solid polymer electrolyte comprises a structural support.

Embodiment 55. The electrochemical cell of any one of Embodiments 49-54, wherein the structural support of the solid polymer electrolyte comprises an inert polymer mesh.

Embodiment 56. The electrochemical cell of any one of Embodiments 49-55, wherein the inert polymer mesh comprises polyethylene, polyethylene terephthalate, PVDF, a cellulose derivative, polyimide, or polyether-ether-ketone.

Embodiment 57. The electrochemical cell of any one of Embodiments 49-56, wherein the inert polymer mesh has a porosity between 50% and 90% and a thickness between 0.1 micron and 10 microns.

Embodiment 58. The electrochemical cell of any one of Embodiments 49-57, wherein the inert structurally supporting mesh is placed on the electrode prior to deposition of the solid polymer electrolyte.

Embodiment 59. The electrochemical cell of any one of Embodiments 49-58, wherein the growing of the solid polymer electrolyte on the second electrode or cathode comprises applying an electrochemical potential to the second electrode or cathode when the second electrode or cathode is immersed in the solution mixture.

Embodiment 60. The electrochemical cell of any one of Embodiments 49-59, wherein the deposition process occurs via a chemical or electrochemical reaction of a lithium-TDI salt and a cyclic carbonate solvent (to form a polycarbonate off of the first and second electrode).

Embodiment 61. The electrochemical cell of any one of Embodiments 49-60, wherein the solid polymer electrolyte has a thickness ranging between 0.1 microns to 10 microns.

Embodiment 62. The electrochemical cell of any one of Embodiments 49-61, wherein the solid polymer electrolyte that is lithium ion conductive and electrically insulating.

Embodiment 63. The electrochemical cell of any one of Embodiments 49-62, wherein the solid polymer electrolyte is grown directly on the first electrode or anode.

Embodiment 64. The electrochemical cell of any one of Embodiments 49-63, wherein the solid polymer electrolyte is grown directly on the second electrode or cathode.

Embodiment 65. The electrochemical cell of any one of Embodiments 49-64, wherein the solid polymer electrolyte comprises a portion of solvent swollen within the solid polymer electrolyte, wherein the portion of swollen solvent reacts with a growing dendrite to form polymers on the dendrite (SELF-HEALING).

Embodiment 66. The electrochemical cell of any one of Embodiments 49-65, wherein a fluorinated ethylene carbonate is used as a crosslinking agent for the solid polymer electrolyte.

Embodiment 67. The electrochemical cell of any one of Embodiments 49-66, wherein the polymer is a polycarbonate or a carbonate containing polymer with a monomer composition determined by a composition of organic carbonate liquid mixture.

Embodiment 68. The electrochemical cell of any one of Embodiments 49-67, wherein the solid polymer electrolyte is polymerized to the surface of the first or second electrode.

Embodiment 69. The electrochemical cell of any one of Embodiments 49-68, wherein the polymer adheres to the anode via a chemical reduction reaction of lithium 2-Trifluoromethyl-4,5-Dicyanoimidazolide, which initiates a polymerization of carbonate liquids on the surface of the anode.

Embodiment 70. The electrochemical cell of any one of Embodiments 49-69, wherein the polymer is adhered to the cathode via an electrochemical reduction reaction of lithium 2-Trifluoromethyl-4,5-Dicyanoimidazolide, which initiates the polymerization of the carbonate liquid onto the surface of the cathode.

Embodiment 71. The electrochemical cell of any one of Embodiments 49-70, wherein the adherent microporous polymer is deposited or adhered to at least one face of at least one electrode by electrodeposition, chemical reduction, electrochemical reduction, or immersion of the electrode in a corresponding solution containing organic carbonates and a dissociable lithium salt.

Embodiment 72. The electrochemical cell of any one of Embodiments 49-71, wherein the microporous polymer comprises self-healing properties as a result of the specific mixture of dissociable lithium salt, carbonate solvent mixture, and lithium metal surface.

Embodiment 73. The electrochemical cell of any one of Embodiments 49-72, wherein the adherent microporous polymer prevents dendrite growth due to its self-healing properties.

Embodiment 74. The electrochemical cell of any one of Embodiments 49-73, wherein the adherent microporous polymer resists fracture and cracking as a result of vibrational and shock forces typically seen in battery use in electric vehicles.

Embodiment 75. The electrochemical cell of any one of Embodiments 49-74, wherein microstructure of the polymer is determined via a ratio between fluorinated ethylene carbonate and cyclic carbonate solvent.

Embodiment 76. The electrochemical cell of any one of Embodiments 49-75, wherein chemical and/or electronic properties of the polymer are determined via a ratio between fluorinated ethylene carbonate and cyclic carbonate solvent.

Embodiment 77. The electrochemical cell of any one of Embodiments 49-76, wherein growing the solid polymer electrolyte on the anode occurs via an electrochemical reaction of a lithium TDI salt and a cyclic carbonate solvent.

Embodiment 78. The electrochemical cell of any one of Embodiments 49-77, wherein the solution mixture is an electrolyte solution comprising one or more organic carbonates containing a dissociable lithium salt in a concentration between 0.1 M and 1.5 M.

Embodiment 79. The electrochemical cell of any one of Embodiments 49-78, wherein a concentration of lithium 2-Trifluoromethyl-4,5-Dicyanoimidazolide (LiTDI) is between 0.1 M and 1.5 M.

Embodiment 80. The electrochemical cell of any one of Embodiments 49-79, wherein the one or more organic carbonates comprise ethylene carbonate, dimethyl carbonate, ethyl-methyl carbonate, propylene carbonate, fluorinated ethylene carbonate, or a mixture thereof.

Embodiment 81. The electrochemical cell of any one of Embodiments 49-80, wherein the one or more organic carbonates comprise fluorinated ethylene carbonate in a concentration of between 10 ppm and 100,000 ppm.

Embodiment 82. The electrochemical cell of any one of Embodiments 49-81, wherein at least a portion of the solid polymer electrolyte comprises a porous portion.

Embodiment 83. The electrochemical cell of any one of Embodiments 49-82, wherein the porous portion of the solid polymer electrolyte are swollen with an organic liquid and a dissociable lithium salt.

Embodiment 84. The electrochemical cell of any one of Embodiments 49-83, wherein the dissociable lithium salt dissolved in an organic liquid comprises one or more of lithium 2-Trifluoromethyl-4,5-Dicyanoimidazolide, lithium hexafluorophosphate, lithium triflate, lithium triflimide, lithium perchlorate, lithium tetrafluoroborate, or lithium bistriflimide.

Embodiment 85. The electrochemical cell of any one of Embodiments 49-84, wherein the anode current collector comprises a metal mesh made of copper, aluminum, or stainless steel.

Embodiment 86. The electrochemical cell of any one of Embodiments 49-85, wherein the anode current collector has a thickness of about 5 microns to about 200 microns.

Embodiment 87. The electrochemical cell of any one of Embodiments 49-86, wherein the anode current collector is a porous mesh comprising pores within the anode current collector and wherein a porosity of the anode current collector ranges from 25% to 75%.

Embodiment 88. The electrochemical cell of any one of Embodiments 49-87, wherein the pores of the anode current collector are filled or substantially filled with lithium when the battery is charged.

Embodiment 89. The electrochemical cell of any one of Embodiments 49-88, wherein the pores of the anode current collector are devoid or substantially devoid of lithium when the battery is discharged.

Embodiment 90. The electrochemical cell of any one of Embodiments 49-89, wherein the anode comprising a metal mesh filled with lithium metal does not change volume as the battery charges or discharges.

Embodiment 91. The electrochemical cell of any one of Embodiments 49-90, wherein the substrate is electrically conducting.

Embodiment 92. The electrochemical cell of any one of Embodiments 49-91, wherein the substrate comprises a non-electrically conducting material.

Embodiment 93. The electrochemical cell of any one of Embodiments 49-92, wherein the solid polymer electrolyte comprises a polymer ceramic composite material.

Embodiment 94. The electrochemical cell of any one of Embodiments 49-93, wherein the solid polymer electrolyte comprises one or more ion conducting ceramic or inorganic materials.

Embodiment 95. The electrochemical cell of any one of Embodiments 49-94, wherein the solid polymer electrolyte comprises one or more from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 96. The method of any one of Embodiments 1-48, wherein the solid polymer electrolyte comprises a polymer ceramic composite material.

Embodiment 97. The method of any one of Embodiments 1-48 or 96, wherein the solid polymer electrolyte comprises one or more ion conducting ceramic or inorganic materials.

Embodiment 98. The method of any one of Embodiments 1-48, 96, or 97, wherein the solid polymer electrolyte comprises one or more from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 99. A method of preparing a lithium battery, comprising: providing a first electrode; forming a solid polymer electrolyte on the first electrode; and placing a second electrode against the solid polymer electrolyte, thereby forming the battery, wherein, during operation, the solid polymer electrolyte is capable of growing a passivating polymer layer at an interface between the first electrode and the solid polymer electrolyte.

Embodiment 100. The method of Embodiment 99, wherein the solid polymer electrolyte comprises a portion of solvent swollen within the solid polymer electrolyte, wherein, during operation, the portion of swollen solvent reacts with a growing dendrite to form polymers on the dendrite.

Embodiment 101. The method of Embodiments 99 or 100, wherein a fluorinated ethylene carbonate is used as a crosslinking agent for the solid polymer electrolyte.

Embodiment 102. The method of any one of Embodiments 99-101, wherein the solid polymer electrolyte is polymerized to a surface of the first or second electrode.

Embodiment 103. The method of any one of Embodiments 99-102, wherein the passivating polymer layer is microporous and comprises self-healing properties as a result of a mixture of dissociable lithium salt, carbonate solvent mixture, and lithium metal surface.

Embodiment 104. The method of Embodiment 103, wherein the passivating polymer layer is adherent to the first and/or second electrode and prevents dendrite growth due to its self-healing properties.

Embodiment 105. The method of any one of Embodiments 99-104, wherein, prior to placing the second electrode against the solid polymer electrolyte, further comprising: applying an electrochemical potential to the second electrode when the second electrode is immersed in a solution mixture of a dissociable lithium salt and a carbonate solvent mixture, thereby forming a layer of solid polymer electrolyte on the second electrode.

Embodiment 106. The method of Embodiment 105, wherein the forming of the solid polymer electrolyte on the first electrode and the forming of the layer of solid polymer electrolyte on the second electrode occurs concurrently.

Embodiment 107. The method of any one of Embodiments 99-106, wherein the solid polymer electrolyte comprises a polymer ceramic composite material or one or more ion conducting ceramic or inorganic materials.

Embodiment 108. The method of any one of Embodiments 99-107, wherein the solid polymer electrolyte comprises one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 109. The method of any one of Embodiments 99-108, wherein the first electrode comprises a lithium metal, lithium foil, a treated copper foil, treated copper foil a graphite, a lithiated graphite, LiC₆, a lithium ceramic glass, Li₄Ti₅0i₂, Li_{4,4}Si, or Li_{4,4}Ge bound together with polyvinylidene fluoride (PVDF), or the second electrode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

Embodiment 110. An electrochemical cell comprising: a first electrode having a solid polymer electrolyte deposited thereon, the solid polymer electrolyte comprising a microporous polymer swollen with an organic carbonate liquid and a dissociable lithium salt;

and a second electrode.

Embodiment 111. The electrochemical cell of Embodiment 110, wherein, during operation, the solid polymer electrolyte is capable of growing a passivating polymer layer at an interface between the first electrode and the solid polymer electrolyte.

Embodiment 112. The electrochemical cell of Embodiment 111, wherein the passivating polymer layer is adherent to the first and/or second electrode and prevents dendrite growth due to its self-healing properties.

Embodiment 113. The electrochemical cell of any one of Embodiments 110-112, wherein the solid polymer electrolyte comprises a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 114. A method of preparing an electrochemical cell, comprising: providing a first electrode; immersing the first electrode in an electrolyte solution; depositing a solid layer of electrolyte on the immersed first electrode; and attaching a second electrode to an exposed surface of the solid layer of electrolyte, thereby forming the electrochemical cell.

Embodiment 115. The method of Embodiment 114, wherein the solid layer of electrolyte comprises a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 116. The method of Embodiments 114 or 115, wherein the solid layer of electrolyte comprises a microporous polymer swollen with an organic carbonate liquid and a dissociable lithium salt.

Embodiment 117. The method of any one of Embodiments 114-116, wherein, during operation, the solid layer of electrolyte is capable of growing a passivating polymer layer at an interface between the first electrode and the solid layer of electrolyte.

Embodiment 118. The method of Embodiment 117, wherein the passivating polymer layer is adherent to the first and/or second electrode and prevents dendrite growth due to its self-healing properties.

1. A method of preparing a lithium battery, comprising:
providing a first electrode;
forming a solid polymer electrolyte on the first electrode; and
placing a second electrode against the solid polymer electrolyte, thereby forming the battery,
wherein, during operation, the solid polymer electrolyte is capable of growing a passivating polymer layer at an interface between the first electrode and the solid polymer electrolyte.

2. The method of claim 1, wherein the solid polymer electrolyte comprises a portion of solvent swollen within the solid polymer electrolyte, wherein, during operation, the portion of swollen solvent reacts with a growing dendrite to form polymers on the dendrite.

3. The method of claim 1, wherein a fluorinated ethylene carbonate is used as a crosslinking agent for the solid polymer electrolyte.

4. The method of claim 1, wherein the solid polymer electrolyte is polymerized to a surface of the first or second electrode.

5. The method of claim 1, wherein the passivating polymer layer is microporous and comprises self-healing properties as a result of a mixture of dissociable lithium salt, carbonate solvent mixture, and lithium metal surface.

6. The method of claim 5, wherein the passivating polymer layer is adherent to the first and/or second electrode and prevents dendrite growth due to its self-healing properties.

7. The method of claim 1, prior to placing the second electrode against the solid polymer electrolyte, further comprising:
applying an electrochemical potential to the second electrode when the second electrode is immersed in a solution mixture of a dissociable lithium salt and a carbonate solvent mixture, thereby forming a layer of solid polymer electrolyte on the second electrode.

8. The method of claim 7, wherein the forming of the solid polymer electrolyte on the first electrode and the forming of the layer of solid polymer electrolyte on the second electrode occurs concurrently.

9. The method of claim 1, wherein the solid polymer electrolyte comprises a polymer ceramic composite material or one or more ion conducting ceramic or inorganic materials.

10. The method of claim 1, wherein the solid polymer electrolyte comprises one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

11. The method of claim 1, wherein:
the first electrode comprises a lithium metal, lithium foil, a treated copper foil, treated copper foil a graphite, a lithiated graphite, LiC₆, a lithium ceramic glass, Li₄Ti₅0i₂, Li_{4,4}Si, or Li_{4,4}Ge bound together with polyvinylidene fluoride (PVDF), or
the second electrode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

12. An electrochemical cell comprising:
a first electrode having a solid polymer electrolyte deposited thereon, the solid polymer electrolyte comprising a microporous polymer swollen with an organic carbonate liquid and a dissociable lithium salt; and
a second electrode.

13. The electrochemical cell of claim 12, wherein, during operation, the solid polymer electrolyte is capable of growing a passivating polymer layer at an interface between the first electrode and the solid polymer electrolyte.

14. The electrochemical cell of claim 13, wherein the passivating polymer layer is adherent to the first and/or second electrode and prevents dendrite growth due to its self-healing properties.

15. The electrochemical cell of claim 12, wherein the solid polymer electrolyte comprises a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

16. A method of preparing an electrochemical cell, comprising:
providing a first electrode;
immersing the first electrode in an electrolyte solution;
depositing a solid layer of electrolyte on the immersed first electrode; and
attaching a second electrode to an exposed surface of the solid layer of electrolyte, thereby forming the electrochemical cell.

17. The method of claim 16, wherein the solid layer of electrolyte comprises a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

18. The method of claim 16, wherein the solid layer of electrolyte comprises a microporous polymer swollen with an organic carbonate liquid and a dissociable lithium salt.

19. The method of claim 16, wherein, during operation, the solid layer of electrolyte is capable of growing a passivating polymer layer at an interface between the first electrode and the solid layer of electrolyte.

20. The method of claim 19, wherein the passivating polymer layer is adherent to the first and/or second electrode and prevents dendrite growth due to its self-healing properties.
